(19) United States
(12) Patent Application Publication
(10) Pub. No.: US 2009/0094093 A1
(43) Pub. Date: Apr. 9, 2009

(54) SYSTEM FOR SELECTING ADVERTISEMENTS

(75) Inventor: Thomas Phan, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/868,252

(22) Filed: Oct. 5, 2007

(51) Int. Cl. G06F 17/30; G06F 17/40; G06Q 30/00

(52) U.S. Cl. 705/10

(57) ABSTRACT

A system for selecting an advertisement for display to a user. The system includes a plurality of web properties and an advertisement engine. Each of the web properties include a web interface that may be customized based on user profile data provided by the user. As such, data may be explicitly associated with the user's profile naturally over time as the user interacts with various web pages and sets user preferences. Upon visiting one of the web properties, the web interface may request an advertisement for the advertisement engine to be displayed to the user. The advertisement engine identifies the user and accesses the user profile data for the identified user stored in each of the web properties. The advertisement engine also accesses advertisement target profile data associated with an advertisement and compares the user profile data to the advertisement target profile data to determine whether to display the advertisement to the user.

### BACKGROUND

1. Field of the Invention

The present invention generally relates to a method and system for selecting advertisements.

2. Description of Related Art

Many online search engines and content providers generate revenue by posting advertisements on their web pages. Often advertisers will pay to place their advertisement on web pages that have content related to their product or service. While content on a page may be somewhat topic specific, the content and the ad may not necessarily be relevant to the user. Online search engines are also often used as a platform to deliver specific ads to users. This is generally accomplished when users submit their queries to a search engine, which would then try to match the entered keywords to web pages that contain the keywords or have been associated with the keywords through some methodology. The user is then provided with a list of search results that are ranked in order of relevance, and generally, advertisements may be matched with the results. Although an advertisement may be related to the results, it still may not be optimally selected based on the user's true interests. Therefore, the user may be viewing advertisements for which they have little interest, thus resulting in a lower click through rate. This outcome is not in alignment with the goals of the advertisers, who want to present their advertisements to users that are particularly interested in their products or services.

In addition, some advertisements are related to products or events that will occur at a specific time or over a certain range of dates. In order to promote a specific event, advertisers can follow one of several solutions that may be implemented by Internet advertising companies. Blanket campaigns can spread advertising indiscriminately to promote the brand, in this case the information that the event is occurring. More specific campaigns can target certain properties (webpage families or websites) where the visiting users' demographics and location are known. For more specificity, behavioral targeting can track users' past history and infer their interests, while contextual advertising will deliver ads relevant to the current page that the user is visiting. None of these methods provide an adequate solution to the problem described above. Each solution delivers ads with targeting that is too coarse to reliably reach the users that are the most likely to positively react to the advertiser. If advertisers cannot reliably reach the most desired users, advertisers may avoid or limit online advertising. As such, the online service providers will miss the revenue generated by the advertising and the advertisers will miss opportunities to reach potential customers.

In view of the above, it is apparent that there exists a need for an improved method and system for selecting advertisements.

### SUMMARY

In satisfying the above need, as well as overcoming the drawbacks and other limitations of the related art, a need for an improved method and system for selecting advertisements is provided.

In one exemplary embodiment, the system includes a plurality of web properties and an advertisement engine. Each of the web properties include a web interface that may be customized based on user profile data provided by the user. The web properties store the user profile data, for example in a database, for later retrieval. When a user visits one of the web properties, the web interface may request an advertisement for the advertisement engine to be displayed to the user. The advertisement engine identifies the user and accesses the user profile data for the identified user stored in each of the web properties. The advertisement engine also accesses advertisement target profile data associated with an advertisement and compares the user profile data to the advertisement target profile data to determine whether to display the advertisement to the user. Alternatively, the system may display a generic advertisement or compare the advertisement target profile data of a new advertisement to the user profile information.

As such, data is explicitly associated with the user's profile naturally over time as the user interacts with various web pages and sets user preferences. By intersecting data that is explicitly associated by the user, there is no need for inferencing such as what is done with other targeting methodologies.

This intersection of data can be used for the delivery of advertisements for transient events. Such transient events may include sporting events (whether on TV or live at a stadium), TV shows, and concerts, and the advertising campaign may be for branding or for CPA (cost-per-acquisition) purposes. Unlike advertising for long-lived products or for particular seasons, ads for transient events are short-lived and must have alstronger and more immediate impact on users before the event transpires. Businesses that advertise transient events want their advertisements to be delivered to users who are interested in participating in the event or are looking to purchase related products.

The challenges for such transient event advertising are to: (1) meet the advertiser's scheduling constraints for ad delivery before the event becomes stale; (2) satisfy user interest preferences in order to deliver relevant ads; (3) meet user access medium constraints, such as particular TV/cable/dish provider or geographic locality.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for selecting advertisements.

FIG. 2 is another schematic view of a system for selecting advertisements.

FIG. 3 is an illustration of a flowchart for a method of selecting advertisements.

### DETAILED DESCRIPTION

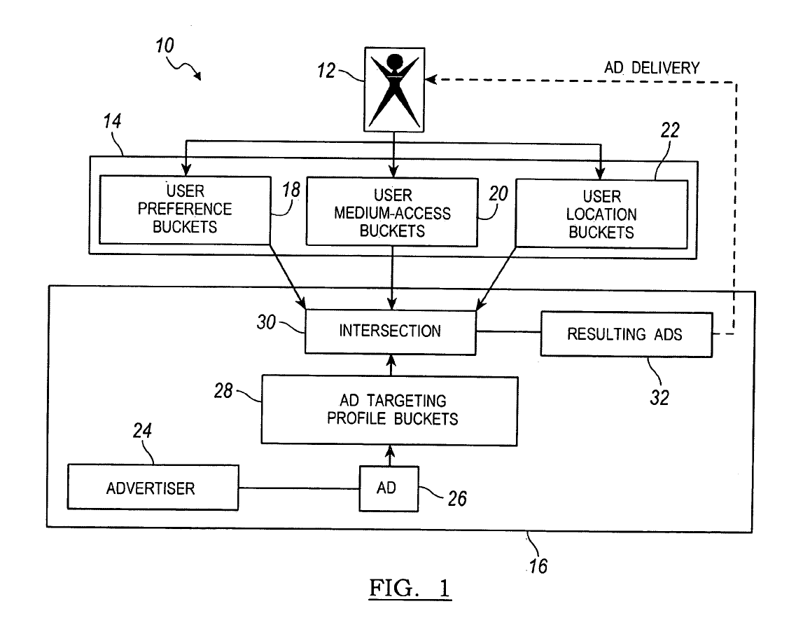

Now referring to FIG. 1, a system 10 is provided for selecting advertisements to be displayed, for example in a web-based application. The system 10 includes web portals 14 and an advertisement engine 16 which may be interacted with by a user 12. The user 12 may interact with one or more web-based portals as denoted by reference number 14. The applications implementing the web portals 14 may be a single application but also may take the form of multiple properties, where each property includes subject specific content. In addition, each property may track and store a number of subject specific profile parameters for each user. The profile data attributes may be stored on a server hosting the property or alternatively may be stored locally on the user's machine. As such, the user interface on the web portals 14 may facilitate storage of user preference buckets 18, user medium access buckets 20, and user location buckets 22.

The user preference buckets 18 may include information such as favorite sports, favorite sports teams, favorite music artists, as well as other user selected preferences for various subject specific properties. Similarly, the user medium access buckets 20 may include information regarding media available to the user. The user medium bucket 20 may include information, such as local radio stations, satellite radio subscribed to by the user, cable service subscribed to by the user, satellite dish subscription, the user's internet service provider, or other information media available to the user. The user location buckets 22 may include user location information, such as the region, the state, the county, the city, or the zip code of the user. In addition, this information may also be used in conjunction with user schedule and/or travel information which may later be used to determine if a user is a candidate for an event at a specific location or at a specific time.

The advertisement engine 16 includes advertisements 16, advertisement targeting profile buckets 28, and an intersection engine 30. The advertisement engine 16 receives user profile data from the web portals 14 and provides the user profile data from the user preference buckets 18, user medium access buckets 20, and user location buckets 22. In addition, the advertiser 24 is equally interested in making sure that their advertisements 26 are shown to a user having a profile compatible with the advertiser's product. As such, the advertiser 24 generates advertisements 26 that are categorized within the advertisement engine 16 as denoted by block 28. The advertisements 26 are categorized using an advertising target profile data corresponding to the predefined parameters available in the user preference buckets 18, the user medium access buckets 20, and the user location buckets 22. As such, the advertisement engine 16 performs an intersection at the intersection engine 30 of the advertisement targeting profile defined in block 28 and the user profile as assembled from the various buckets within the web portals 14. After the operation of the intersection engine 30, resulting ads 32 are available for delivery to the user 12.

The intersection of the advertisement targeting profile with the user profile may be performed using a number of methods. In one example, each of the criteria of the ad targeting profile must match exactly to the assembled user profile. In another example, a number of advertisement targeting profile parameters must match a threshold number of user profile parameters for the advertisement to be displayed. In yet another example, each advertisement targeting profile parameter may be weighted and a threshold score set. In this example each user profile parameter that matches the ad targeting profile parameter is assigned a weighted score and if the cumulative score for the parameters is greater than the threshold, the advertisement is displayed. Alternatively, a generic advertisement may be displayed. As such, if the intersection of the ad targeting profile and the user profile is positive, the resulting advertisement is delivered to the user 12 as denoted by block 32.

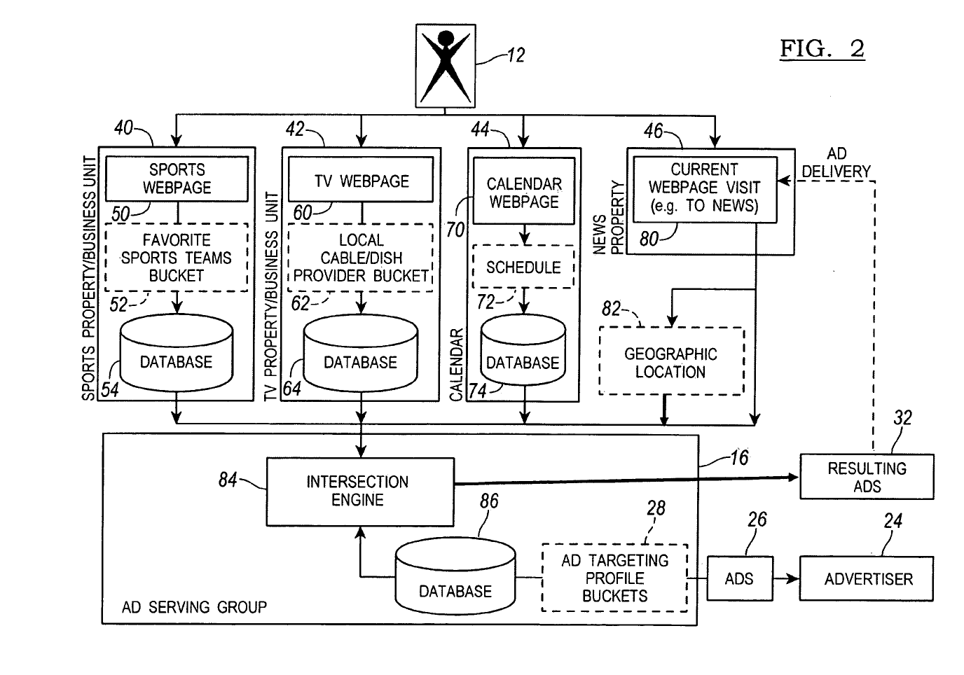

Now referring to FIG. 2, a specific implementation of the system 10 is provided utilizing a number of web properties to determine the user profile. As such, the user 12 may access one of a number of properties over time. For example, the user 12 may access a sports property 40 which contains subject specific content related to sports. In addition, the sports property 40 may include a sports web page 50 that allows the user to customize content based on user preferences. The user preferences may include information such as the user's favorite sport, the user's favorite sports teams for each sport, whether the user is interested in professional, collegiate, or amateur sports, as well as, similar preferences. In this example, the sports property 40 stores at least the user's favorite sports teams as denoted by block 52. In addition, the user's favorite sports teams 52 may be stored in a database 54 for future access. The database 54 may be stored on a server for the sports property 40 or alternatively may be stored on the user's local system, for example, in the form of a cookie.

Similarly, the user 12 may also access a TV property 42 including a TV web page 60. The TV web page 60 may provide updated TV listings to the user. To provide a more focused TV listing including local channels, the user may input user profile data for example, the user's favorite stations, whether the user 12 subscribes to a cable or dish provider, and, specifically, to which cable or dish provider the user 12 subscribes. In this example, the TV property 42 stores at least the local cable or dish provider to which the user 12 subscribes, as denoted by block 62. The local or cable dish provider 62 to which the user 12 subscribes may be stored in a database 64. As noted previously with regard to database 54, the database 64 may be stored on the TV property server or locally on the user's system. As such, the database 64 may be accessed to provide TV listings, including updated channel assignments or local offerings by each cable provider. In addition, the database 64 is available for future access to determine TV property parameters assigned by the user 12.

Further, additional web properties may be provided including services such as email properties, task list properties, contacts properties, or calendar properties. As can be readily understood, each of the user parameters set for each of these properties may also be used and accessed for selecting advertisements. As an example of a service property, the calendar property 44 is provided. The calendar property 44 may include a calendar web page 70 including a calendar display allowing the user 12 to input and access calendar information for scheduling purposes. In addition, the schedule information including for example appointments, as denoted by block 72, are stored in a database 74. In the case of transient advertisements, where an advertisement is being advertised for a specific date, the service properties may be particularly useful. For example, the calendar property 44 may provide user schedule data, such as appointments 72, to compare with the event date and identify if the user has an appointment that conflicts with the event.

The database 74 may typically be stored on the server, but may be stored on the user's local machine. The user profile information stored on databases 54, 64, and 74 may be stored over time as the user 12 utilizes the various properties 40, 42, 44 and/or customizes the properties 40, 42, 44. As such, when the user 12 accesses a property, in this example news property 46, a web page 80 may be accessed and accordingly an advertisement requested from the advertisement engine 16. The request for the advertisement from the web page 80 may also initiate the advertisement engine 16 to access the user profile data stored in the databases 54, 64, 74. As such, the advertisement engine 16 may retrieve information including the user's favorite sports teams 52, the user's local cable dish provider 62, the user's schedule 72, and even user geographic information as denoted by block 82, which may be derived via the user's IP address or alternatively stored in one of the property databases such as database 54, 64, 74. However, it should be noted that all the user profile information may be provided or available for access by the intersection engine 84 of the advertisement engine 16.

Similar to the user setting user profile data to provide easy access to content of interest, the advertiser 24 desires to display advertisements 26 to users having user profile data that have indicated an interest in the advertiser's product. As such, the advertiser defines an advertisement target profile, as denoted by block 28. Accordingly, the advertiser may determine a combination of the defined user profile parameters that form an advertisement targeting profile 28 for each advertisement 26 and store the advertisement targeting profile 28 into a database 86 on the advertisement engine server. The intersection engine 84 may receive and/or access the advertisement targeting profile parameters from the database 86 after determining that the advertisement 26 should be displayed on bid or space allocation criteria or other common advertisement placement criteria.

The intersection engine 84 may compare the user profile data and the advertisement target profile data 28 using various methodologies. Some exemplary implementations are described with respect to Tables 1-3 provided below.

TABLE 1
Sports Property

| User Key | Favorite Sports | Favorite Teams |
|---|---|---|
| XXXX1 | Boxing | — |
| XXXX2 | Boxing | Jets |
| XXXX3 | Football | Jets |
| XXXX4 | Football | Bills |

An exemplary database including user profile data, is provided in Table 1. The user profile data in Table 1 corresponds to user profile data collected for the sports property 40. The sports property 40 is a web portal for topic specific content related to sports. As such, common information that would be collected by the portal to customize the content for the user might include the user's favorite sports and the user's favorite sports teams, as well as other profile data.

TABLE 2
TV Property

| User Key | Media Provider | Location |
|---|---|---|
| XXXX1 | Comcast | San Francisco |
| XXXX2 | Dish Network | San Francisco |
| XXXX3 | Comcast | New York |
| XXXX4 | Comcast | New York |

An exemplary database for the TV property 42 is provided in Table 2. The user profile data in Table 1 corresponds to user profile data collected for the TV Property 42. The TV property 42 is a web portal for topic specific content related to television, for example, television show listings. As such, common information that would be collected by the portal to customize the content provided to the user might include the user's media provider and the user's home location, as well as other profile data.

TABLE 3

| | | | Media | | |
|---|---|---|---|---|---|
| | Advertisement | Sports | Provider | Teams | Location |
| AD1 | Jets Football | Football | — | Jets | New York |
| | Tickets | | | | |
| AD2 | Pay Per View | Boxing | Comcast | — | San |
| | Boxing | | | | Francisco |

An exemplary data base including advertisement target profile information is provided in Table 3. As such, the advertiser 24 may be interested in marketing Football Tickets for the New York Jets only to users who have indicated that football is one of their favorite sports, the Jets is one of their favorite teams, and they reside in New York. Accordingly, the advertiser 24 would indicate these preferences in the advertisement target profile data 28, as denoted in the row corresponding to AD1 of Table 3.

In one implementation, the intersection engine may display the advertisement only to users that match all of the three selected criteria. According to this analysis, only User XXXX3 would be shown the advertisement AD1. In another implementation, the intersection engine may display the advertisement if a threshold number of user profile parameters match the advertisement target profile parameters selected for the advertisement AD1. Since the advertisement AD1 is only concerned with the favorite sport, favorite team, and location parameter, only these parameters will be compared by the intersection engine 84. As such, the threshold could be 66% or 2 of the 3 parameters matching. Accordingly, User XXXX3 and User XXX4 would be shown the advertisements, while User XXXX1 and User XXXX2 would not be shown the advertisement. User XXXX3 matches all of the parameters or 100%. However, User XXXX4 matches the Sport and Location parameters, but not the Favorite Team parameter for a score of 66%.

Alternatively, the parameters may be compared based on a weighted score. For example, the parameters may be compared based on the formula A*Parameter 1+B*Parameter 2+C*Parameter 3, where A, B, C, are values assigning weight to each parameter. In one exemplary implementation, Parameter 1=Sport, Parameter 2=Location, Parameter 3=Favorite Team and the weightings are A=0.5, B=0.3, and C=0.2. As such, the score for the Users are:

User XXXX1 is (0.0+0.0+0.0)=0.0;

User XXXX2 is (0.0+0.0+0.2)=0.2;

User XXXX3 is (0.5+0.3+0.2)=1.0;

User XXXX4 is (0.5+0.3+0.2)=0.8.

If a threshold value of 0.8 is employed the advertisement AD1 would be shown to both User XXXX3 and User XXXX4. As can be seen in this scenario, the difference between User XXXX4 and User XXXX2 is much more significant using a weighted comparison and various weighting schemes can be applied to differentiate relevant parameters.

In another example, an advertisement for a pay per view boxing match may be evaluated, as denoted by the advertisement AD2. In the example for the advertisement the advertisement AD2, Parameter 1=Sport, Parameter 2=Media Access Provider, Parameter 3=Location and the weightings may be A=0.4, B=0.5, and C=0.1. As such, the score for the Users would be:

User XXXX1 is (0.5+0.4+0.1)=1.0;

User XXXX2 is (0.5+0.0+0.1)=0.6;

User XXXX3 is (0.0+0.4+0.0)=1.0;

User XXXX4 is (0.0+0.4+0.0)=0.8.

If a threshold value of 0.5 is employed the advertisement would be shown to User XXXX1 and User XXXX2. However, a generic advertisement would be shown to User XXXX3 and User XXXX4.

Four additional scenarios are discussed below to provide examples of other properties and advertisements that may be utilized in conjunction with the system and methods described above.

Scenario 1: A television network (such as NBC, ESPN, or FOX SPORTS) or a local TV station is showing a basketball game between two teams within the next few days. This game is of particular interest to fans of the teams, and the network wishes to attract as many such viewers as possible by providing a branding message letting the fans know that the game will be on its network. It is difficult to identify these users, and even then, users have different media access constraints, such as their cable or satellite provider, so the game may not be accessible by a particular user based on media access constraints. The system may be utilized by the television network to identify appropriate users.

Users are initially categorized into buckets based on their stated preferences available through internet properties such as a sports property (such as Yahoo! Sports offered by Yahoo! Inc., Sunnyvale Calif.) or a service property (such as My Yahoo!, also offered by Yahoo! Inc.) For example, users can be placed into one of 33 buckets (one for each of the 32 NBA teams and one for no stated preference). Users are also bucketized according to what television programming provider they have set in the TV property (such as Yahoo! TV). The network advertiser's targeted profile is set as fans of the two teams that also have cable/dish provider that carry the network. When the ad for the advertiser is scheduled to be served for the user, the users interest-bucket and medium-access-bucket and the advertiser's targeting-profile bucket are intersected. The advertiser's ad for this game is shown to the user, otherwise a generic ad is displayed.

A new and novel aspect of this approach is that explicitly stated data (in the form of users' favorite sports teams, users' TV provider, and the advertisers' target profile) are intersected. There is no need for inferencing such as done with behavioral targeting methodologies.

Scenario 2: A ticket brokering service (such as TICKETMASTER) wishes to promote an upcoming rock concert to be held in San Francisco within the next few months. The advertiser wishes to target users who are interested in the rock band or in that genre of music. Additionally, the advertiser wishes to target users who are in the Bay Area, as they are most likely to buy tickets.

To target the right audience, users are initially categorized into buckets representing musical bands and genres based on information from a music property (such as Yahoo! Music/Launchcast). The users are also bucketized based on their geographic location. The advertiser's ad is also bucketized based on a targeting profile (e.g. “rock music” and “San Francisco Bay Area” zip codes). When the advertiser's ad is scheduled for delivery to the user, all buckets are intersected, and the ad may be delivered. An advantageous aspect of this approach is that data for the users' interests are taken from explicit preferences without need for inferring the users' interest.

Scenario 3: A transient event advertiser wishes to target users to participate in a future event, but many users have already made prior engagements that conflict with the event and will more likely ignore advertising for the upcoming event. The advertiser still wishes to advertiser to these users, but in a fashion that works within the constraints of the users' scheduling workflow. The system may be optimized to fit the promoted event within a user's scheduled workflow.

As with the above two scenarios, the users and the ads are bucketized and then intersected to determine if the ad is to be delivered. The user's calendar system is further leveraged in this case. If the transient event fits into the corresponding time slot in the user's calendar, the ad is displayed there. Otherwise, the ad may be displayed in an adjacent position in the calendar layout or not presented to that particular user.

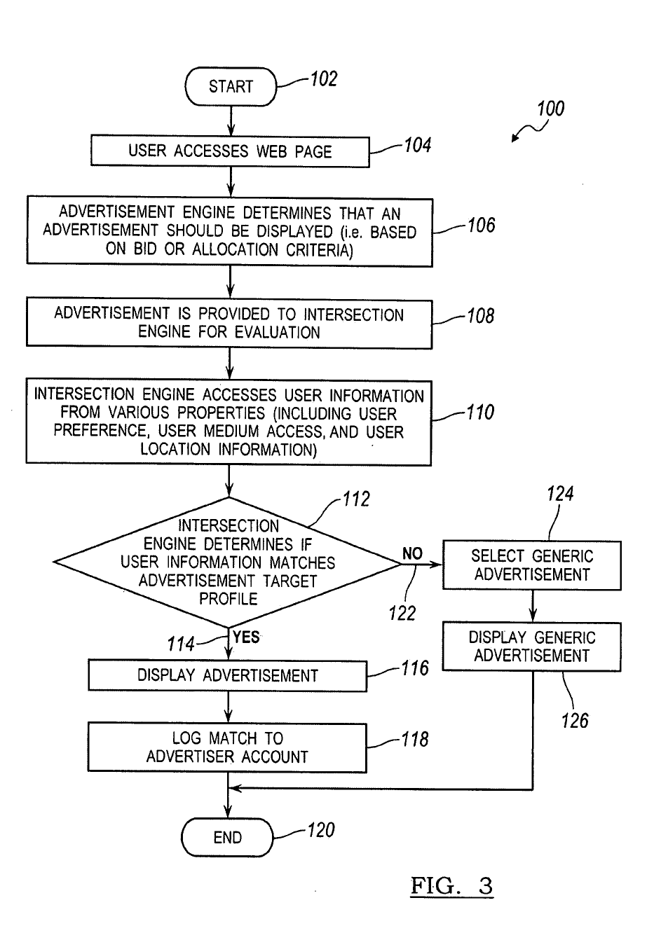

In conjunction with the above scenarios, a method 100 embodying the principles of the invention is shown in FIG. 3. The method 100 starts in block 102 and proceeds to block 104 where the user accesses a web page. As such, the web page requests an advertisement from the advertisement engine. As noted in block 106, the advertisement engine determines that an advertisement should be displayed based on advertisement allocation criteria. The advertisement allocation criteria may include a bidding model and/or a form of scheduling model. The advertisement scheduled by the advertisement engine is provided to the intersection engine for evaluation as noted by block 108. The intersection engine accesses user profile data from various properties to determine if the user information matches the advertisement target profile data, as denoted by block 110. The user profile data may be accessed from various web properties and may include user preference information, user median access information, user location information, or any combination of the above. As denoted by block 112, the intersection engine determines if the user profile data matches the advertisement target profile. If the user profile data matches the advertisement target profile, the method follows line 114 to block 116 and the advertisement is provided to the user system for display. In addition, the advertisement engine logs the match to the advertiser account which may be used for statistical or accounting purposes, as denoted by block 118. Alternatively, if the user information does not match the advertisement target profile, the method follows line 122 to block 124. In block 124, the advertisement engine selects a generic advertisement applicable to a large audience of users. The advertisement engine then provides the generic advertisement to the user system for display as denoted by block 126. The method proceeds to end in block 120.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

I claim:

1. A system for selecting advertisements for display to a user, the system comprising:
a plurality of web properties, each web property of the plurality of web properties having a web interface corresponding to a subject specific topic, the web interface being configured to receive user profile data from the user and configure information provided through the web interface based on the user profile data, each web property being configured to store the user profile data;
an advertisement engine configured to receive advertisement target profile data associated with an advertisement, the advertisement engine comprising an intersection engine configured to compare the user profile data to the advertisement target profile data to determine whether to provide the advertisement associated with the advertisement target profile data for display to the user.

2. The system according to claim 1, wherein the plurality of web properties share a user key associated with a user account assigned to the user and the user profile data is stored based on the user key by each web property.

3. The system according to claim 1, wherein the user profile data is stored in a database on a server for the web property

4. The system according to claim 1, wherein the user profile data is stored in a database on a local machine of the user.

5. The system according to claim 1, wherein the user profile data includes user schedule data and the intersection engine is configured to compare the user schedule data to the advertisement target profile data.

6. The system according to claim 5, wherein the advertisement target profile data includes an event date and the intersection engine is configured to compare the user schedule data to the event date.

7. The system according to claim 1, wherein the user profile data includes user medium access data and the intersection engine is configured to compare the user medium access data to the advertisement target profile data.

8. The system according to claim 1, wherein the user profile data includes user location data and the intersection engine is configured to compare the user location data to the advertisement target profile data.

9. The system according to claim 1, wherein the user profile data includes user preference data and the intersection engine is configured to compare the user preference data to the advertisement target profile data.

10. The system according to claim 1, wherein the intersection engine is configured to calculate a score based on a comparison of each parameter of the advertisement target profile data to a corresponding parameter in the user profile data.

11. The system according to claim 10, wherein the score is calculated according to a weighting of each parameter of the advertisement target profile data.

12. A method for selecting advertisements for display to users, the method comprising the steps of:
receiving user profile data through a plurality of web properties;
storing the user profile data for later retrieval;
receiving advertisement target profile data associated with an advertisement from an advertiser;
storing the advertisement target profile data;
determining that an advertisement should be considered for display;
accessing the user profile data;
accessing the advertisement target profile data;
comparing the user profile data to the advertisement target profile data;
determining whether to display the advertisement based on a comparison of the user profile data to the advertisement target profile data.

13. The method according to claim 12, wherein the plurality of web properties share a user key associated with a user account assigned to the user and the user profile data is stored by the user key

14. The method according to claim 12, wherein the user profile data is stored in a database on a server for the web property

15. The method according to claim 12, wherein the user profile data is stored in a database on the local machine of the user.

16. The method according to claim 12, wherein the user profile data includes user schedule data and further comprising comparing the user schedule data to the advertisement target profile data.

17. The system according to claim 16, wherein the advertisement target profile data includes an event date and further comprising comparing the user schedule data to the event date.

18. The method according to claim 12, wherein the user profile data includes user medium access data and further comprising comparing the user medium access data to the advertisement target profile data.

19. The method according to claim 12, wherein the user profile data includes user location data and further comprising comparing the user location data to the advertisement target profile data.

20. The method according to claim 12, wherein the user profile data includes user preference data and further comprising comparing the user preference data to the advertisement target profile data.

21. A system for selecting advertisements for display to a user, the system comprising:
a web property having a web interface, the web interface being configured to receive user profile data from the user and configure information provided through the web interface based on the user profile data;
an advertisement engine configured to receive advertisement target profile data including an event date associated with an advertisement, the advertisement engine comprising an intersection engine configured to compare the user profile data to the event date to determine whether to provide the advertisement associated with the advertisement target profile data for display to the user.

22. The system according to claim 21, wherein the user profile data includes user schedule data and the intersection engine is configured to compare the user schedule data to the event date.

23. The system according to claim 21, wherein the web property is one web property of a plurality of web properties, each web property of the plurality of web properties having a web interface corresponding to a subject specific topic, the web interface of each web property being configured to receive user profile data from the user.

24. The system according to claim 23, wherein the web property configures information provided through the web interface to the user based on the user profile data.

25. The system according to claim 24, wherein each web property being configured to store the user profile data.
